(19) United States
(12) Patent Application Publication
(10) Pub. No.: US 2022/0391966 A1
(43) Pub. Date: Dec. 8, 2022

(54) AUTOMATICALLY HANDLING ELECTRONIC ORDERS

(71) Applicant: VOXP PTE. LTD., Singapore (SG)

(72) Inventor: Dennis Beltran MENDIOLA, Ventura, CA (US)

(73) Assignee: VOXP PTE. LTD., Singapore (SG)

(21) Appl. No.: 17/776,230

(22) PCT Filed: Nov. 13, 2019
(86) PCT No.: PCT/SG2019/050559

§ 371 Date: May 12, 2022

(51) Int. Cl. G06Q 30/06

(52) U.S. Cl. CPC G06Q 30/0635; G06Q 30/0609; G06Q 30/0627

(57) ABSTRACT

A method for automatically handling electronic orders is disclosed. The method includes receiving an order indication indicating an electronic order for an item by a customer. The method further includes determining a security value based on the order indication and initiating a transfer of at least one digital valuable from a first account associated with the customer to a second account based on the security value. In this manner, a seller of the item is provided with a security or a deposit in the form of the digital value. A system implementing the method is also disclosed.

### 1. TECHNICAL FIELD

The present invention relates to the automatic handling of electronic orders.

### 2. BACKGROUND OF THE INVENTION

Developing countries hold immense growth potential for online shopping and e-commerce. As of today, in developing countries, online sales account for only a small fraction of total retail sales as compared to countries like the United States, Japan and Korea. The main obstacles to realizing this growth potential are disposable income, challenging logistics and the scarcity of online payment options given that the majority of the population in the developing countries is without convenient access to remote payment mechanisms like credit cards or online banking. It is estimated that more than 9 out of 10 online purchases made, e.g., in the Philippines are transacted on cash basis.

Yet, despite these obstacles, topline growth at a remarkable rate year-on-year could be observed for the past years. This trend has largely been fuelled by innovation in delivery systems, including the ever more pervasive use of “sharing economy” approaches in the corresponding logistics, the streamlining of customs practices as well as, not least, the introduction and smarter handling of Cash on Delivery (COD) as a payment method. COD is analogous to postpaid payment schemes in mobile telephony services. Payment is made after proper calculation of usage, or in the case of online shopping, once an item has been delivered.

COD has enabled millions of individuals to shop online by circumventing the need for access to remote payment mechanisms like credit cards or online banking which is lacking in the developing markets as outlined above. Moreover, given the lower disposable income of customers and the limitations imposed by small vehicular delivery systems, the majority of purchases made in developing markets is for smaller items, e.g., items that could fit in motorcycle storage bins. It is estimated that the average online transaction in developing markets hovers around USD 10.00 to USD 20.00. Such sums are well suited to be balanced in cash upon delivery.

But COD comes with its own set of problems.

One issue is the safety of delivery personnel, especially as the people involved begin to handle larger amounts of cash, and in a motorcycle.

Another issue is that merchants and vendors are often “left holding the bag.” For example, for a mobile telephone service, those who delay or default on payment for their monthly service are easily compelled to pay with the threat of their phone lines being cut. But this is not the case with COD where, in case of a failed (e.g., unpaid, cancelled or no-show) delivery, the item must be returned to the merchant or to a local depot for “refurbished”or “open box” reselling.

There may be many reasons for a failed delivery. The buyer may simply not be present at the shipping address. Or he has changed his mind, refused delivery for other reasons, or does not even have the necessary cash at that time. It is the merchant and the logistics provider who bear the risk, or are “left holding the bag,” so to speak. Notably, this risk is comparatively substantial: Studies suggest that taking back an item in the course of a failed delivery costs at the very least four times more than it cost to have it sent to the shipping address.

And yet, online merchants must provide COD as a payment method, at least for low value, small items. They must take on the risks, lest they lose the larger race to build a massive customer base. Apart from striving hard to hit valuation targets, companies need the numbers to exploit economies of scale and scope.

Hence, there is a need to tame the spiraling cost of COD cancellations. A safer and more efficient way of distributing low-value items to a rapidly growing customer base is necessary. In this way, COD for online purchases may become a highly sustainable mode of e-commerce for the emerging markets.

### 3. SUMMARY OF THE INVENTION

In a first aspect, the above need is at least partly met by a computer-implemented method according to independent claim 1.

In an example, such a computer-implemented method automatically handles electronic orders. It may comprise the steps of receiving an order indication indicating an electronic order for at least one item by a customer. For example, the order indication may be received from the customer or it may be received from, e.g., an online shop at which the customer may have placed the order. The method may further comprise determining a security value based on the order indication, and initiating a transfer of at least one digital valuable from a first account associated with the customer to a second account based on the security value.

Thus, a computer-implemented method may be provided that provides the seller of an item, for example an online shop, with a security or a deposit in the form of a digital valuable that is determined based on the order indication. This may be of particular interest where the customer desires to pay upon delivery, i.e., where the customer chooses to pay using COD. By transferring the digital valuable to a second account different from the first account associated with the customer, the risk of a failed delivery is diminished. The customer will be eager not to forfeit at least one digital valuable functioning as his deposit. Moreover, if the second account is associated with the seller, he may monetize the digital valuable, e.g., by reselling it, in order to help pay for any costs that accrued due to a failed delivery that led to the forfeiture of the at least one digital valuable. As such, the present invention may overcome many of the problems identified above.

Particularly, relying on digital valuables in this regard is advantageous as they may be transferred electronically and as such instantly and remotely. Hence, they may allow to automatize and speed up the handling of electronic orders. Moreover, digital valuables may by definition be fungible and very pervasive; nowadays, digital valuables may even be as widespread as cash itself. Hence, the use of digital valuables may enable a vast number of people to participate in electronic orders, e.g., when shopping online.

By determining the security value based on the order indication, e.g., based on database queries as outlined further below, the value of the digital valuable, e.g., prepaid airtime credit, can be chosen to balance the interests of the customer and the seller.

Generally, for example, any form of prepaid credit may be used as a digital valuable in the sense of the present invention. One example of a particularly well-suited form of prepaid credit is prepaid airtime credit as used in mobile telephony. In fact, prepaid airtime credit may be the most pervasive digital valuable—almost akin to an “electronic currency”—in many developing countries like, e.g., the Philippines. Through innovation in the handling of prepaid airtime, such as the ability for it to be transferred peer to peer, it can also well be described as fungible. So, for example, if a customer decides to order an item online and to pay for it by COD, a transfer of a certain amount of prepaid airtime credit may be initiated when the order is placed. The transferred prepaid airtime may then function as a deposit.

Additionally or alternatively, instead of using a digital valuable such as prepaid airtime credit, the customer could also be charged with a Value Added Service charge or an Operator billing charge against a (prepaid) account he has with the corresponding Mobile Network Operator (MNO).

Another example for a suitable digital valuable is a cryptocurrency. Generally speaking, a cryptocurrency is a digital asset designed to work as a medium of exchange that uses strong cryptography to secure financial transactions, to control the creation of additional units, and to verify the transfer of assets. Cryptocurrencies use decentralized control as opposed to centralized digital currency and common, central banking systems. The decentralized control of cryptocurrency usually works through distributed ledger technology, typically a so-called blockchain, that serves as a public financial transaction database. The most well-known cryptocurrencies are Bitcoin, Ethereum(TM) and Facebook(TM)'s upcoming Libra(TM). Despite the decentralized control, cryptocurrency may often be easier and quicker to transfer than traditional currency due to lack of institutional oversight and regulation and hence bureaucracy.

The method may further comprise receiving a completion indication indicating whether delivery and/or payment of the at least one item have been completed successfully and initiating a reversal of the transfer of the at least one digital valuable based on the completion indication. Hence, it may be ensured that the digital valuable is only transferred back to the first account if the delivery and/or the corresponding payment of the at least one item have been completed successfully. Vice versa, if delivery and/or payment have not been completed successfully, reversing the transfer may be refrained from. In some examples, another try at delivery and/or payment may be made at a later point in time in such cases. In other examples, the digital valuable may be transferred to a third account, e.g., in return for a service, traditional money or some different digital valuable, instead of being transferred back to the first account associated with the customer if delivery and/or payment of the at least one item fail. By processing whether delivery and/or payment have been completed successfully with the help of a completion indication that may by definition be received electronically, the handling of the electronic order may be further automatized and/or sped up.

The first account associated with the customer and/or the second account may be associated with at least one subscriber identity module, SIM. Associating the accounts with a SIM may render the handling of electronic orders and in particular the transfer of the at least one digital valuable easier and more time- as well as cost-efficient since already existing infrastructures, e.g., those provided by MNOs, may be relied on.

The second account may be associated with a plurality of SIMs. For example, a whole array of SIMs may be used, thereby creating one or more so-called SIM banks. SIM banks may host hundreds or even thousands of SIMs. Each of the SIMs therein is capable of receiving digital valuables such as prepaid airtime credit transferred from first accounts associated online shoppers for escrow or deposit purposes according to the present invention. With the right algorithm, one SIM may be capable of serving hundreds of shoppers a day. Accordingly, associating the second account with a plurality of SIMs may allow quick processing of a large number of transfers of digital valuables and hence electronic orders.

Distributing digital valuables transferred to the second account among the plurality of SIMs may add to these effects. For example, such distributing may be performed by an algorithm that is based on prioritization or simply in a round-robin scheme. Either way, gains in speed and efficiency may be the result.

In particular, at least two SIMs of the plurality of SIMs may be associated with different telephone numbers. This may render the method according to the present invention independent of any special approval by an MNO, e.g., in case the digital valuable comprises prepaid airtime credit. Rather than setting up a special account that may need to be certified and/or approved by the MNO, such as a so-called “master dealer wallet” account, the entity employing the present invention may simply use a—possibly large—number of conventional SIMs. Each of these SIMs corresponds to a separate, actual subscriber to the MNO, such that existing, standard regulations and practices apply to each of them. This may in turn increase ease of use, availability and (cost-)efficiency of the method according to the present invention.

Additionally or alternatively, at least two SIMs of the plurality of SIMs may be associated with an identical telephone number, preferably a virtual telephone number. That is, rather than managing an array of different telephone numbers—possibly as many as there are SIMs associated with the second account—only a few or even only a single telephone number may need to be managed, at least with a view to transfers of digital valuables such as prepaid airtime credit. This may enhance ease of use, speed and efficiency of handling electronic orders. Moreover, using actual telephone numbers to conduct business may appear to many as unprofessional, unlike using a specifically chosen virtual telephone number, e.g., a dedicated shortcode. Moreover, entities employing the methods according to the present invention, e.g., third parties such as payment service providers or sellers or merchants themselves, may customize the telephone number that is to be used by customers. For example, an online shop may process deposits according to the present invention using a dedicated shortcode that reflects the name of the website.

Initiating the transfer of the at least one digital valuable may comprise transmitting a request for the transfer of the at least one digital valuable to a mobile network operator and/or to the customer. For example, the merchant itself or the third party processing the payments for the merchant may ask an MNO to transfer a suitable amount of prepaid airtime credit from the customer's account to another account as a deposit. Possibly, the customer would have to agree to the transfer, e.g., by replying to a message sent to his phone or via a dialogue box appearing on the merchant's or payment service provider's own website or app. In other examples, the merchant or the payment service provider may transmit the request to the customer straight away. This could circumvent involving the MNO and thereby lengthly internal approval issues and even regulatory ones. Either way, existing infrastructure may be used, thereby rendering the handling of electronic orders and in particular the transfer of digital valuables therein easier and more time- as well as cost-efficient.

Determining the security value may further be based on at least one first predetermined criterion, such as a price of the at least one item, a size of the at least one item, the weight of the at least one item, a difficulty of packaging the at least one item, a cost of delivery of the at least one item, the cost of returning the at least one item, a resale value of the at least one item, a credit score of the customer, whether the first account associated with the customer is the customer's own account or a credit risk profile of the customer. For example, one, two, three, or any other number of first predetermined criterion may be used. In some examples, the one or more criterion may not be predetermined but depend on the order indication and/or the customer. For example, the credit risk may only be used in case of a price that is above a threshold, or the resale value may only be used if the customer is known to have returned items before.

Generally speaking, the security value, on which the transfer of the at least on digital valuable is based, must be significant enough to compel the customer (or a third party associated with the customer, such as a family member or a friend) to not let the deliver fail, i.e., e.g. to be home and pay for the item upon delivery if COD is chosen as a payment method. The same holds true if the customer is supposed to pick up the ordered at least one item at an agreed upon drop-off location. The security value must then be determined such as to ensure that the customer goes out of his way to visit the drop-off location to pay and pick up his purchase. Broadly speaking, the risk of a delivery failing may on the one hand correlate with at least one of the ordered item, e.g., its price, size, weight, the costs of sending as well as returning and reselling the item, but it may also correlate with the customer, e.g., his credit score and/or credit risk profile. Therein, it may also be of relevance whether the first account from which the digital valuable is to be transferred as a deposit is the customer's own or, e.g., that of a friend or a family member. Artificial intelligence, big data analytics and similar technologies may be used to take one or more of these criteria into account and/or to weigh them appropriately.

One or more of these criteria may be stored in a database that is accessed when determining the security value. This may enhance access and computation times, in effect rendering the handling of electronic orders and initiating a transfer of digital valuables according to the present invention quicker and more efficient.

In a further aspect, the present invention relates to a system with means for implementing the above methods. Such a system may therefore comprise means for receiving an order indication indicating an electronic order for at least one item by a customer, means for determining a security value based on the order indication, and means for initiating a transfer of at least one digital valuable from a first account associated with the customer to a second account based on the security value. The system may be or reside in a server, and it may include the mentioned database as well as artificial intelligence and big data analytics functions. The system may further be adapted to implement the methods and steps as outlined above and as described in further detail below.

In another aspect, the present invention relates to a computer-implemented method for automatically handling electronic orders that comprises the steps of receiving an order indication indicating an electronic order for at least one item by a customer and determining at least one drop-off location for the at least one item based on the order indication.

Hence, a method may be provided that allows to automatically determine the—possibly optimum—drop-off location for delivery of an electronically ordered item, hence enhancing the handling of corresponding electronic orders. Automating this determination is of particular importance when there is a large number of drop-off locations available. In fact, the management of a large number of drop-off locations may even only be rendered feasible at all with the help of the above method. This is especially relevant as “sharing economy” approaches are growing in popularity and pervasiveness. In such approaches, individuals or small business and shop owners allow, e.g., their homes to become drop-off locations for neighbors, often for a fee or a commission. As such, they may agree to accept deliveries, e.g., from online merchants, to hold packages for pickup or even deliver to homes of customers themselves. Moreover, they may agree to accept cash payments on behalf of payment service providers, e.g. payment service providers employing the present invention, and remit the payments to them. This way, the present invention may help overcome the logistical challenges of delivering a dizzying array of low-priced items to online shoppers spread over largely rural and suburban areas.

Determining the at least one drop-off location may further be based on at least one second predetermined criterion such as a distance between the at least one drop-off location and an address of the customer, the price of the at least one item, the size of the at least one item, the weight of the at least one item, a size of a packaging of the at least one item, an urgency of delivery, the reliability associated with the at least one drop-off location or opening hours of the at least one drop-off location. Generally speaking, such criteria determine which is, after all, the actual optimum drop-off location. For instance, if the electronically ordered item is heavy and unwieldy, more emphasis may be put on a distance between the at least one drop-off location and an address of the customer when determining the drop-off location, whereas if the item is small but particularly valuable, reliability and security associated with the at least one drop-off location may trump distance. Artificial intelligence, big data analytics and similar technologies may be used to take one or more of the above criteria into account and/or to weight them appropriately to determine the true optimum drop-off location. If a customer ordered more than one item, the drop-off location may be determined to be different for each of these items. In such cases, more than one drop-off location may be determined.

One or more of the above criteria may be stored in a database that is accessed, e.g., when determining the at least one drop-off location. This may enhance access and computation times, in effect rendering the handling of electronic orders and the determination of the at least one drop-off location according to the present invention quicker and more efficient.

Determining candidates for a drop-off location may also comprise determining a correlation value between the customer and the drop-off location and/or a correlation value between the order indication and the drop-off location. That is, a value may be determined that reflects how well a drop-off location may meet the customer's needs and preferences, e.g., regarding opening times. Similarly, a value may be determined that reflects how well a drop-off point is suited to handle delivery of a certain electronically ordered item. For example, smaller drop-off locations may be less suited to handle the delivery of a large number of heavy and unwieldy items, while drop-off locations poorly connected to common traffic infrastructure may be less suited to deliver perishable goods such as food. Determining such correlation values may ensure that the optimum drop-off location can be determined particularly efficiently. For example, this may allow for a particularly clear and simple ranking of different drop-off locations without requiring elaborate comparisons and hence computing power, thereby speeding up the determination of the at least one drop-off location.

In a further aspect, the present invention relates to a system implementing the above methods. Such a system may therefore comprise means for receiving an order indication indicating an electronic order for at least one item by a customer, and means for determining at least one drop-off location for the at least one item based on the order indication. The system may be or reside in a server, and it may include the mentioned database, artificial intelligence and big data analytics functions. The system may further be adapted to implement the methods and steps as outlined above and as described in further detail below.

In yet another aspect, the present invention relates to a computer-implemented method for automatically handling electronic orders, comprising the steps of processing a payment for an electronic order for at least one item by a customer at a drop-off location and forwarding the payment at least partially to a second account.

For example, the payment may be a full payment for the item, but it may only be forwarded partially, i.e., at least a part of the payment may be retained at the drop-off location, such that in effect a loan is extended to the drop-off location. Conversely, the payment may not be a full payment for the item, but only a partial payment. This (partial) payment may then be forwarded in full, such that in effect a loan is extended to the customer. Such loans may, for example, be paid back at a later point in time, possibly also stepwise over time, for example with interest.

Hence, a method may be provided that allows, e.g., to extend credit to customers and drop-off locations or their operators, respectively. As described above, for example, individuals or small business and shop owners may operate such drop-off locations and may hence be provided with credit using the above method. This may be particularly desirable as some of these operators, just as customers, may be without convenient access to, e.g., online banking or a bank account in the first place, as outlined above. The method may, for example, allow to extend credit on a cash basis without requiring the borrower to have access to online banking or the like, while at the same time still allowing for a computer-implemented processing and handling of the credit, thereby enhancing the overall speed, efficiency and security of the corresponding process.

The drop-off location may be determined using one of the methods already described above. Therein, determining the—possibly optimum—drop-off location, may also be based on whether or not the operator of the drop-off location desires credit.

Of course, any of the aspects discussed above and/or below may also be combined. For instance, a single system may be implemented that, upon receiving an order indication indicating an electronic order for at least one item by a customer, on the one hand determines a security value based on the order indication and initiates a transfer of at least one digital valuable from a first account associated with the customer to a second account based on the security value and that on the other hand also determines at least one drop-off location for the at least one item based on the order indication. Such systems may be implemented, e.g., by payment service providers or by merchants, such as online shops, themselves. Moreover, the determined at least one drop-off location or its operator(s), respectively, may desire credit and may hence process a payment for the electronic order for the at least one item by the customer at the drop-off location and may forward the payment only partially to a second account, which may be the same second account as the one used in the transfering the at least one digital valuable. In some examples, this second account may also be a different second account than that used in the transferring of the at least one digital valuable, but it may nevertheless be associated with the same entity, e.g., a payment service provider employing at least some of the methods described herein. Moreover, upon processing the payment, e.g., the drop-off location or its operator, respectively, may transmit a completion indication indicating whether delivery and/or payment of the at least one item have been completed successfully. This completion indication may be received and, based thereon, a reversal of the transfer of the at least one digital valuable may be initiated as described above.

Generally, aspects described herein with reference to a method also apply to corresponding systems or means for implementing the respective method. In the same vein, in yet another aspect, the present invention relates to a computer program comprising instructions which, when the program is executed by a computer, cause the computer to carry out any of the methods discussed herein, alone or in combination.

### 4. BRIEF DESCRIPTION OF THE FIGURES

Possible examples of the present invention will be described in more detail in the subsequent detailed description with reference to the following figures:

FIG. 1: Flowchart of an example of a method according to the present invention;

FIG. 2: Flowchart of another example of a method according to the present invention;

FIG. 3: Schematic view of an example of a system according to the present invention;

FIG. 4: Schematic view of another example of a system according to the present invention.

### 5. DETAILED DESCRIPTION OF POSSIBLE EXAMPLES

For the sake of brevity only a few examples will be described in the following. The skilled person will recognize that the specific features described with reference to these examples may be modified and combined differently and that individual features may also be omitted if they are not essential. The general explanations in the sections above will also be valid for the following more detailed explanations.

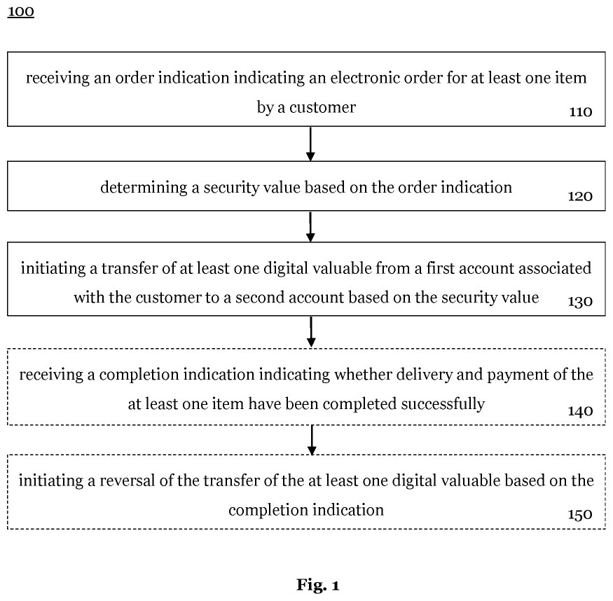

FIG. 1 shows an example of a computer-implemented method 100 for automatically handling electronic orders according to the present invention. Method 100 may begin with step 110 of receiving an order indication indicating an electronic order for at least one item by a customer. Method 100 may then proceed to step 120 of determining a security value based on the order indication. The determining the security value of step 120 may further be based on at least one first predetermined criterion. In some examples, the at least one first predetermined criterion comprises at least one of: a price of the at least one item, a size of the at least one item, the weight of the at least one item, the difficulty of packaging the at least one item, a cost of delivery of the at least one item, the cost of returning the at least one item, a resale value of the at least one item, a credit score of the customer, a credit risk profile of the customer. To this end, method 100 may further comprise the step of accessing a database in which the at least one first predetermined criterion is stored. Method 100 may further include step 130 of initiating a transfer of at least one digital valuable from a first account associated with the customer to a second account based on the security value. In some examples, the first account associated with the customer and/or the second account may be associated with at least one subscriber identity module, SIM. In particular, in some examples, the second account may be associated with a plurality of SIMs. At least two SIMs of the plurality of SIMs may be associated with different telephone numbers. Additionally or alternatively, at least two SIMs of the plurality of SIMs may also be associated with an identical telephone number, preferably a virtual telephone number. A digital valuable transferred to the second account may be distributed among the plurality of SIMs. Step 130 of initiating the transfer of the at least one digital valuable may in some examples comprise transmitting a request for the transfer of the at least one digital valuable to a mobile network operator and/or to the customer. In some examples, method 100 may further comprise step 140 of receiving a completion indication indicating whether delivery and/or payment of the at least one item have been completed successfully and/or step 150 of initiating a reversal of the transfer of the at least one digital valuable based on the completion indication.

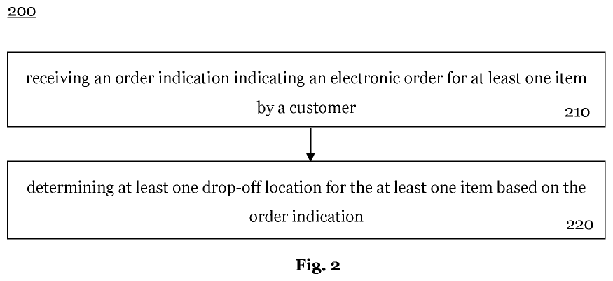

FIG. 2 shows another example of a computer-implemented method 200 for automatically handling electronic orders according to the present invention Method 200 comprising the step 210 of receiving an order indication indicating an electronic order for at least one item by a customer as well as step 220 of determining at least one drop-off location for the at least one item based on the order indication. Step 220 of determining the at least one drop-off location may further be based on at least one second predetermined criterion. The at least one second predetermined criterion may comprise at least one of: a distance between the at least one drop-off location and an address of the customer, the price of the at least one item, the size of the at least one item, the weight of the at least one item, a size of a packaging of the at least one item, an urgency of delivery, a reliability associated with the at least one drop-off location, opening hours of the at least one drop-off location. To this end, method 200 may further comprise the step of accessing a database in which the at least one second predetermined criterion is stored. Step 220 of determining the at least one drop-off location may optionally comprise step of determining a correlation value between the customer and the drop-off location and/or a correlation value between the order indication and the drop-off location.

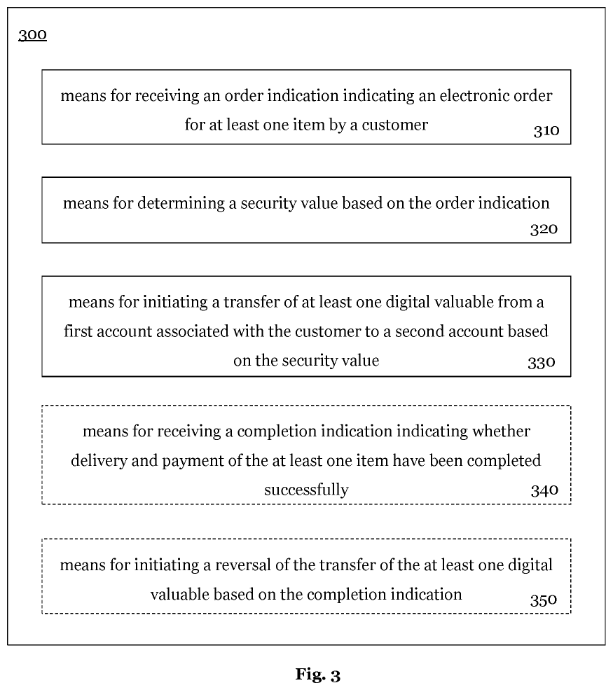

FIG. 3. shows a schematic view of an example of a system 300 for automatically handling electronic orders according to the present invention. System 300 comprises means 310 for receiving an order indication indicating an electronic order for at least one item by a customer, means 320 for determining a security value based on the order indication; and means 330 for initiating a transfer of at least one digital valuable from a first account associated with the customer to a second account based on the security value. Optionally, system 300 may comprise means 340 for receiving a completion indication indicating whether delivery and/or payment of the at least one item have been completed successfully and means 350 for initiating a reversal of the transfer of the at least one digital valuable based on the completion indication.

Those of skill in the art will appreciate that the various means, as well as the method steps described herein may be implemented as electronic hardware, computer software, or combinations of both, e.g. to implement the functionality described herein mainly with reference to method steps. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure. The methods, sequences or algorithms described herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

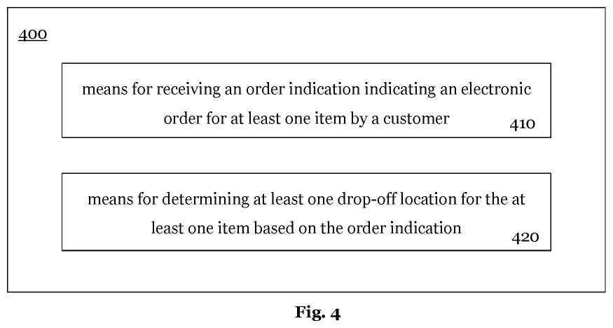

FIG. 4. shows a schematic view of another example of a system 400 for automatically handling electronic orders according to the present invention. System 400 comprises means 410 for receiving an order indication indicating an electronic order for at least one item by a customer and means 420 for determining at least one drop-off location for the at least one item based on the order indication.

In the following, the operation of an exemplary system according to the present invention will be described in detail. In this example, the present invention is employed by a payment service provider, i.e., by an entity that is different from the online shop at which the customer electronically orders the desired item, which shall be assumed to be a Bluetooth speaker costing USD 15.00 including shipping here. However, in other examples, the present invention may also be employed by an online shop directly. Moreover, a deposit shall be provided in the form of a mobile prepaid airtime credit.

On day one, the following happens:

1. The customer finds the Bluetooth speaker in an online shop and begins the checkout process.
2. He specifies a shipping address which may be assumed to be his home address. However, generally, a customer may specify any, arbitrary shipping address, the present invention does not impose any restrictions in this regard.
3. The customer lives in an area in which traditional COD is not available, e.g., due to lacking infrastructure.
4. When the customer reaches the payment section during the checkout process, thus, several modes of payment are presented, including of course a credit card, but the traditional COD option is greyed out.
5. However, the customer can instead select “enhanced COD” and also does so.
6. The customer may then be transferred to a different website, e.g., the website of the payment service provider. In other examples, the customer may not be transferred or redirected, though. Rather, the payment service provider may be embedded in the online shop, for example. Either way, the system receives the corresponding order indication.
7. The system then determines a security value based on the order indication, specifically, it begins the process of calculating the amount of prepaid airtime credit that shall be transferred as a deposit to a second account, i.e., an account associated with the online shop and/or the payment service provider.
8. The system determines that USD 5.00 worth of prepaid airtime credit be used as deposit. The customer agrees by clicking on a button, e.g., on the payment service provider's website he was redirected to. Then, the system causes a text to be sent to the customer's mobile phone asking if he agrees to transfer USD 5.00 worth of prepaid airtime credit to the second account. The customer agrees. The system proceeds to take USD 5.00 worth of airtime deposit for the Bluetooth speaker. Here, it is assumed that the customer had already registered with the online shop and/or with the payment service provider and has furnished them with personal information including his mobile phone number. In other examples, the customer may be asked to type in his telephone number. Further, in other examples, the deposit need not be paid necessarily by the customer himself. It could be his friend or a family member, for example. It is noted that whether he pays the deposit himself or not may have an impact on the determination of the security value, i.e., the amount of prepaid airtime credit deemed necessary as deposit as explained elsewhere.
9. The order is placed at this point. The delivery should be expected, e.g., in three days.
10. The payment service provider pays the online shop USD 15.00, the full price of the Bluetooth speaker with shipping.

Subsequently, e.g., three days later, the following happens:

1. The delivery man arrives at the customer's doorstep. In other examples, the electronically ordered at least item, i.e., the Bluetooth speaker, may be delivered to a drop-off location different from the customer's home. The customer would then have to go there in order to obtain the Bluetooth speaker.
2. The customer checks that the Bluetooth speaker is in good order and then pays USD 15.00 in cash. The delivery man, or the operator of the drop-off location, respectively, acknowledges and may also print out a receipt. In addition, a completion indication is sent to the system, indicating that the item has been delivered and paid for.
3. Immediately, the prepaid airtime credit worth USD 5.00 is returned to the customer's account, or to any other account that was used for the deposit. That is, the system initiates a reversal of the transfer of the at least one digital valuable based on the completion indication.

While the average prepaid airtime credit balance of a prepaid mobile subscriber in developing markets such as the Philippines may be below the average online sales transaction, this may not affect the applicability of the present invention. Typically, there is a vast number of venues that are able to sell prepaid airtime credit for cash. In the case of the Philippines, there are several hundred thousand agents of prepaid airtime in comparison to only a handful of traditional convenience stores like 7-11 types. Hence, if need be, a customer lacking prepaid airtime credit to meet the determined amount may easily walk to, e.g., a neighborhood convenience store, or approach a nearby person agent to purchase additional prepaid airtime credit.

The objective of the determination of the security value, that may also be driven by artificial intelligence, is to strike a balance between driving sales of the respective online shop (and, e.g., a commission that may be earned by a payment service provider enabling the online store to offer the method according to the present invention) by extending credit to customers versus being overly conservative in the determination (i.e., the security value may be determined too high such that it dissuades a potential customer from ordering).

If the customer fails to pay and the second account is immediately associated with the payment service provider, the payment service provider may sell the transferred prepaid airtime credit through trade or directly to other mobile subscribers. Thereby, the payment service provider may receive approximately 80 to 85% of the notional amount of the prepaid airtime credit. Similarly, an online shop may monetize on the forfeited prepaid airtime credit if it employs the present invention itself or if the second account is (also) associated with the online shop. The online shop may then use the proceeds to pay for restocking and returns.

The present invention may use artificial intelligence, big data analytics and similar technologies to determine the security value, i.e., e.g., the value of prepaid airtime to be deposited by the customer. As a general rule, the value must be significant enough to compel the customer or a family member to be at the agreed upon drop-off location, e.g., at home, and pay for the item upon delivery, or, in the case of delivery to centralized drop-off locations, to compel the shopper to go out of his way to visit these locations to pay and pick up his purchase. That is, amongst other things, the chances that the customer fails to consummate the transaction and hence forfeits his deposit may be taken into consideration.

The key factors or drivers that influence the determination of the security value may comprise:
value of the item being purchased or ordered, respectively; all things equal, the more valuable the item, the higher the deposit amount,
combination of items being purchased, i.e., e.g., their aggregate value,
packaging dimensions and weight and whether the one or more item may safely be shipped in its original packaging,
handling and delivery costs up to the customer or an agreed-upon drop-off location; vice versa the cost of taking back the item for restocking or possible reselling (possibly with a discount); the more expensive these things are, the larger the security value,
credit score(s) of the customer,
whether the customer will pay for the item himself; all things equal, if the at least one digital valuable is transferred from an account immediately associated with the customer, which may be considered indicative of more certainty of the order, the lower the security value,
whether proper ID has been furnished in the past,
credit risk profile of the shopper; this may for instance be based at least in part on a psychographic analysis of the customer with data taken from a wide variety of sources, including previous purchases by him and similar types of customers, indications of work status and household income, mobile phone behavior (possibly including information that may be shared by the corresponding MNO) and/or social media activity; generally, Information that suggests a person will likely pay up yields a lower security value.

Given that online shops and/or payment service providers earn from repeat users and/or fees that may be paid from the online shop to the payment service provider, the determination of the security value may generally be biased towards lower values.

Typically, to share or transfer prepaid airtime credit, a mobile user may for example text a series of commands, possibly including the amount of airtime credit that is to be sent, to, e.g., a shortcode.

There are a number of ways in which the transfer of prepaid airtime credit may be initiated according to the present invention:

First of all, the transfer may be initiated directly through the corresponding MNO's Intelligent Network(for billing and related)/Business Support Systems/Operations Support Systems (IN-BSS-OSS) system. A system according to the present invention may instruct the MNO to transfer the prepaid airtime credit from the customer's prepaid mobile account to a second account. The second account may be unlike the prepaid accounts held by common MNO subscribers. Such accounts may be referred to as “master dealer” wallet accounts. Such master dealer wallet accounts hold prepaid airtime credit that can be easily resold directly to MNO subscribers. The rules and economics that govern the selling (or reselling) of prepaid airtime credits from master dealer wallet accounts may be similar to, if not identical to, how the MNO's on-ground dealer agents sell prepaid airtime credit and earn from it. In this sense, when prepaid airtime credit is transferred from a customer's prepaid account to the second account, the prepaid airtime credit is transformed back into so-called “dealer airtime credits”. This approach may hence be used without necessitating any changes to the current sales model adopted by the MNO's with their existing agents.

An alternative approach to transferring prepaid airtime credits from a customer that is an MNO subscriber to a second account could also take in the form of a Value Added Service (VAS) charge or an Operator Billing charge against the customer's prepaid account. The MNO would then top up the second account with the same amount the same way an MNO may top up the master dealer wallet accounts of their on-ground dealer agents. The effect is the same as the process described before. This approach may have the added benefit of not having to modify much the MNO's current systems. The disadvantage, however, is that not being integrated directly into the MNO's IN, the transfer process can suffer from system latencies and other inefficiencies. This may cause delays in processing transactions or outright failure in executing the transfer. This problem may be particularly pertinent when volume increases.

Secondly, initiating the transfer may involve so-called SIM banks or modem banks. While the approaches described before are efficient and robust, implementing them may take time and may involve significant expenditures in equipment and software development. SIM banks or modem banks provide a way to overcome these issues, their use requires limited, if any at all, MNO approval. SIM banks or modem banks can host hundreds or even thousands of SIMs, with each SIM representing an actual MNO subscriber account. Each of these SIMs are associated with a corresponding prepaid account that is capable of receiving prepaid airtime credit transferred from customers for escrow or deposit purposes. With the right algorithm, one SIM or the associated account, respectively, may be capable of serving hundreds of customers a day.

These transfers of prepaid airtime credit may be triggered by a wide range of wireless devices, from point of sale (POS) terminals to kiosks to simple 2G-only mobile phones. Tools for transferring prepaid airtime credits may, by now, be accessible to all MNO subscribers. Traditionally, prepaid airtime credit is shared or transferred by simple text- based and Unstructured Supplementary Service Data (USSD)-based commands, easily automated by computers linked up to SIM banks or modem banks.

Upon completion of orders, i.e., when delivery and/or payment have been successfully completed, the transferred prepaid airtime credit is transferred back to the customer. The prepaid airtime credit can be returned from any of the SIMs or accounts associated with the SIM bank.

There is, however, a potential problem with using SIM banks or modem banks. Essentially, they are designed for consumers, not for enterprises and as such are subject to denial-of-service attacks. Moreover, the telephone numbers associated with the SIMs are exposed, visible to users, although this potential problem may be somewhat mitigated by the ability to rotate the use of SIMs. Furthermore, using actual telephone numbers to conduct business may appear to many as unprofessional, unlike using, e.g., a dedicated shortcode. Hence, virtual telephone numbers may be created that may accept prepaid airtime transfers, as well. Such virtual telephone numbers may shorten or mask the telephone numbers associated with the underlying SIMs and may be chosen by online shops or the clients of a payment service provider, respectively, themselves. It may be possible to have several SIMs and/or corresponding prepaid accounts masked by a single vanity number (with proper arrangement with the host MNO). The algorithm for how received airtime is distributed among the SIMs could be based on some sort of prioritization or simply dictated by a round robin scheme.

The present invention may also allow to exploit “sharing economy” schemes, in particular that there has been a growing number of individuals recently who are allowing their homes to become drop-off locations for another, e.g., neighbors, for a fee.

A system, online shop, payment service provider or any other entity employing the present invention may also enable individuals, small businesses and shop owners to apply to become a drop-off location, easily and even remotely. As a drop-off point, they agree to accept deliveries from online merchants, hold packages for pickup or even deliver to, e.g., homes of customers, accept cash payments and remit the payments to, e.g., the online shop or the payment service provider. For their services, the operators of these drop-off locations may be entitled to earn fees and commissions.

Artificial intelligence may drive decisions on which drop-off points are promoted to customers shopping online, including the ones that could no longer receive packages. This may take into consideration a number of factors including, but not limited to, capacity to hold more packages, convenience by which they can be reached by both merchants and customers, transaction history, security of the drop-off locations, risk that packages could be stolen, cash taken as well as the need to spread packages or orders, respectively, across many drop-off locations, though covering areas in proximity.

There are many ways by which, e.g., a payment service operator may earn from the present invention. These include but are not limited to the following:
Charging merchant fees that may be similar to how credit card companies earn from purchases made using the corresponding credit card. Typically ranging from 3% to 5% of the purchase amount, such fees may be borne by sellers/merchants, though sometimes, they may be passed on to customers. Depending on whether the entity employing the present invention is exclusively a payment service provider or whether it also handles delivery, these fees may be higher than those charged by credit card companies since the entity may be handling fulfillment as well as taking on the credit risk. Moreover, such entities may, in some examples, share their earnings with operators of drop-off locations, whether they be large mall networks or neighborhood convenience stores retrofitted to be drop-off locations using an aspect of the present invention. Furthermore, the present invention may provide online merchants/sellers, such as online shops, with an immense value as they may be enabled to reach more customers who, otherwise, would not have had the means to pay for electronically ordered items or those who are not in traditionally deliverable/serviceable locations. Merchants/sellers may also dramatically reduce the incidence of cancellations and no-shows, and in the event customers in fact do not show up, they may have funds to help pay for the expense of recalling a product or reselling a product at a discount. Therefore, charging merchants/sellers higher fees than how credit card companies may be reasonable.
Charging customers handling fees.
Extending credit to customers as they build their shopping history and as more may be learnt about them, e.g., how much they earn, whether they own their own home or not, and similar indicators of financial well-being. Interest may be charged, and a flexible amortization schedule may be provided.
Reselling forfeited prepaid airtime credit, possibly with a trade commission of 15%. The determination of the security value may be set up in such a way that reselling forfeited prepaid airtime credit would more than make up for the cost of restocking, returns, and reselling at a discount.
Microfinancing drop-off locations. For instance, owners of small shops signed up as drop-off location may borrow cash to finance their inventory. For example, instead of expecting full remittance of cash payments received for online purchases, a portion of thereof could be left with the owners with the understanding that there will be charged interest and they have to abide by an amortization schedule. More generally, microfinance companies are constantly searching for ways to extend their reach, to be more cost efficient, to be smarter and to better identify whom they should extend credit to. The logistics of sending cash and collecting from hundreds to thousands of smaller shops present constant challenges. However, small shops serving as drop-off locations according to the present invention may be receiving cash payments from customers electronically ordering items, possibly even to a larger degree than from selling the goods present at the shop themselves. Microfinance companies may simply exploit the means of remitting cash from these shops established for handling electronic orders according to the present invention. We note that Artificial Intelligence, Big Data Analytics, Machine Learning techniques are at the heart of determining whether the small shops and drop off center owners could avail of this type of financing and if so, how much, and over what amortization periods.

The present invention may be applied in a wide range of goods as, more generally, it is a means to compel parties to come through with an agreement.

This may be illustrated using the example of ticket sales for movies. Some cinemas allow reservations on the promise that the buyer will show up before screening and pay cash at the counter upon pick-up. If a customer fails to do so, that is sales forgone. Cinema operators may block this customer for future bookings unless a penalty is paid. However, this may easily be circumvented by registering another email address, another prepaid mobile account/number, or another social media account (used for login).

The present invention may solve this problem by making sure that the penalty for not showing up is paid immediately, as may be illustrated with the help of the following example:

1. The moviegoer goes to the cinema's website to place reservations for a certain number of seats for a particular screening.
2. A security value is calculated, e.g., using artificial intelligence or simply as a percentage of the price of the tickets. A digital valuable, e.g., prepaid airtime credit, is transferred from a first account associated with the customer to a second account, possibly associated with the cinema.
3. The moviegoer then must show up at the cinema at the latest, e.g., 30 minutes before screening, to pay for the tickets. In some examples, the actual time by which he must show up could vary depending on how in-demand the tickets are. Blockbusters, full-house, and special screenings could stipulate 30 minutes, while screenings with modest occupancy may not even impose a deadline at all.
4. If the moviegoer fails to show up on time, he forfeits the prepaid airtime credit which has a certain value and may be resold to mobile subscribers.

A similar system could be set up for services and other perishable items including, but not limited to, food deliveries, spa reservations, repair services, shared cab rides, or any other time-bound services.

In some examples, a cryptocurrency such as Bitcoin, Ethereum(TM) and Facebook(TM)'s upcoming Libra(TM) may be used as digital valuable. While cryptocurrencies are notorious for being volatile in terms of their value or exchange rate with mainstream monies, this is less important when utilizing them for deposits rather than actual payment.

More generally, any digital valuable that may be easily transferred electronically and remotely. Moreover, it should also be fungible and able to store value.

To enhance trust, the present invention may additionally comprise distributed ledger technology such as a blockchain. For example, the whole process of receiving an order indication indicating an electronic order for at least one item by a customer, determining a security value based on the order indication and initiating a transfer of at least one digital valuable from a first account associated with the customer to a second account based on the security value may be tracked using such distributed ledger technology.

The customer then for instance visits the drop-off location and checks out the electronically ordered item. If the shopper approves of the item, he then pays the merchant fully in cash. The blockchain-enabled system is informed thereof, for example via a corresponding completion indication, and then proceeds to initiate the reversal of the transfer of the digital valuable, i.e., it initiates the release of the prepaid airtime credit back to the customer.

The process described here is how “smart contracts” are enforced by blockchain-enabled technology.

If the product does not conform to, e.g., what was advertised, the customer indicates so. A person at the drop-off location, which may be a trusted third party agreed upon in advance, confirms this. Also in this case, the blockchain-enabled system notes this, for example via a corresponding completion indication, and initiates the release of the prepaid airtime credit back to the customer. The merchant may then have to worry about how to get back the package and assumes all costs associated therewith.

However, if the customer does not show up at the drop-off location within a reasonable period of time, e.g., 72 hours upon delivery at the drop-off location, the person at the drop-off point notes this. In turn, the blockchain-enabled system notes this, for example via a corresponding completion indication, and proceeds to direct the prepaid airtime credit to an account associated with the merchant. At this point, the merchant may monetize the prepaid airtime credit himself or he may also sell it to the payment service provider that enabled the transfer of prepaid airtime credit in the first place.

Distributed ledger technology may also be used to track seller and customer activities. This may provide a meaningful rating system for both customers and merchants in which it is not necessary to make public all the details of past dealings. Rather, just enough information may be made public to build one's credibility, e.g., how long has the party been dealing in the marketplaces, how often do they transact, the amounts, the types of items, the comments placed by one party for another, etc. This information may also be relevant in determining the security value.

This, on the other hand, is how blockchain-enabled technology can be used to authenticate and assist various entities in building their reputation as seller, drop off host, and buyer.

Generally, the present invention may be adapted to the needs of arbitrary entities. Order indications according to the present invention may comprise any amount of information. Determining the security value may be based on any criteria that may be weighted according to the needs and goals of the user. Any digital valuable that may be remotely and electronically transferred may be used.

Specific embodiments of the invention have been shown and described in detail with reference to specific examples to illustrate aspects of the invention. However, it will be understood that various modifications and changes may be made thereto without departing from the broader scope of the disclosure as set forth in the appended claims.

1. A computer-implemented method for automatically handling electronic orders, comprising
receiving an order indication indicating an electronic order for at least one item by a customer;
determining a security value based on the order indication; and
initiating a transfer of at least one digital valuable from a first account associated with the customer to a second account based on the security value.

2. Computer-implemented method according to claim 1, further comprising:
receiving a completion indication indicating whether delivery and/or payment of the at least one item have been completed successfully; and
initiating a reversal of the transfer of the at least one digital valuable based on the completion indication.

3. Computer-implemented method according to claim 1, wherein the first account associated with the customer and/or the second account are associated with at least one subscriber identity module, SIM.

4. Computer-implemented method according, wherein the second account is associated with a plurality of SIMs.

5. Computer-implemented method according to claim 4, wherein at least two SIMs of the plurality of SIMs are associated with different telephone numbers.

6. Computer-implemented method according to claim 4, wherein at least two SIMs of the plurality of SIMs are associated with an identical telephone number, preferably a virtual telephone number.

7. Computer-implemented method according to claim 4, wherein the digital valuable transferred to the second account is distributed among the plurality of SIMs.

8. Computer-implemented method according to claim 1, wherein the initiating the transfer of the at least one digital valuable comprises:
transmitting a request for the transfer of the at least one digital valuable to a mobile network operator and/or to the customer.

9. Computer-implemented method according to claim 1, wherein the at least one digital valuable comprises prepaid credit, in particular prepaid airtime credit.

10. Computer-implemented method according to claim 1, wherein the at least one digital valuable comprises a cryptocurrency.

11. Computer-implemented method according to claim 1, wherein the determining the security value is further based on at least one first predetermined criterion.

12. Computer-implemented method according to claim 11, wherein the at least one first predetermined criterion comprises at least one of: a price of the at least one item, a size of the at least one item, a weight of the at least one item, a difficulty of packaging the at least one item, a cost of delivery of the at least one item, a cost of returning the at least one item, a resale value of the at least one item, a credit score of the customer, whether the first account is the customer's own account, a credit risk profile of the customer.

13. Computer-implemented method according to claim 11, further comprising accessing a database in which the at least one first predetermined criterion is stored.

14. A system for automatically handling electronic orders, comprising:
means for receiving an order indication indicating an electronic order for at least one item by a customer;
means for determining a security value based on the order indication; and
means for initiating a transfer of at least one digital valuable from a first account associated with the customer to a second account based on the security value.

15.-20. (canceled).

21. A computer-implemented method for automatically handling electronic orders, comprising:
processing a payment for an electronic order for at least one item by a customer at a drop-off location; and
forwarding the payment at least partially to a second account.

22. Computer-implemented method according to claim 21, wherein the drop-off location is determined using a method comprising:
receiving an order indication indicating an electronic order for at least one item by a customer; and
determining the drop-off location for the at least one item based on the order indication.

23. Computer-implemented method according to claim 21, further comprising transmitting a completion indication indicating whether delivery and/or payment of the at least one item have been completed successfully upon the processing the payment.

24.-25. (canceled).
